(19) United States
(12) Patent Application Publication
(10) Pub. No.: US 2009/0085708 A1
(43) Pub. Date: Apr. 2, 2009

(54) ELECTRONIC DEVICE

(75) Inventors: Tsuyoshi MATSUMOTO, Kawasaki (JP); Xiaoyu Mi, Kawasaki (JP); Takeo Takahashi, Yokohama (JP); Satoshi Ueda, Kawasaki (JP)

Correspondence Address: ARENT FOX LLP, 1050 CONNECTICUT AVENUE, N.W., SUITE 400, WASHINGTON, DC, 20036, US

(73) Assignees: FUJITSU MEDIA DEVICES LIMITED, Yokohama-shi (JP); FUJITSU LIMITED, Kawasaki (JP)

(21) Appl. No.: 12/238,764

(22) Filed: Sep. 26, 2008

(30) Foreign Application Priority Data
Sep. 28, 2007 (JP) 2007-254660

(51) Int. Cl. H01F 5/00

(52) U.S. Cl. 336/200

(57) ABSTRACT

An electronic device includes a substrate, two ellipse spiral coils that are provided on the substrate, are spaced from each other in a longitudinal direction thereof, and are electrically connected to each other, two wires that are electrically connected to outermost circumference of the two coils respectively and extract the two coils to outside, and a connection portion that electrically connects each end of innermost circumference of the two coils. A ratio of inner diameter against outer diameter of the two coils in a long axis direction and in a short axis direction thereof is respectively 0.5 to 0.8.

### BACKGROUND OF THE INVENTION

1. Field of the Invention

The present invention generally relates to an electronic device, and more particularly, to an electronic device having spiral-shaped coils longitudinally spaced from each other.

2. Description of the Related Art

An inductor or a capacitor is used for phase matching or the like. For example, there is a demand for downsizing, low cost and high performance in a RF (Radio Frequency) system such as mobile phone or a wireless LAN (Local Area Network). An electronic device such as an integrated passive device where passive devices such as an inductor or a capacitor are integrated on a substrate is used in order to satisfy the demand.

Japanese Patent Application Publication No. 2006-157738 discloses an integrated electronic device using a spiral-shaped coil on a substrate acting as an inductor. Japanese Patent Application Publication No. 2007-67236 and U.S. Pat. No. 6,518,165 disclose an inductor in which spiral-shaped coils are longitudinally spaced from each other.

In accordance with the inductor disclosed in Japanese Patent Application Publication No. 2007-67236, high Q value (sharpness) is obtained. There is, however, a demand for higher Q value in order to improve the inductor property. In Japanese Patent Application Publication No. 2007-67236 and U.S. Pat. No. 6,518,165, a shape of a spiral coil spaced from each other in a longitudinal direction thereof is schematically illustrated. There is no description of a coil shape obtaining higher Q value.

### SUMMARY OF THE INVENTION

The present invention has been made in view of the above circumstances and provides an electronic device having spiral-shaped coils longitudinally spaced from each other and has higher Q value.

According to an aspect of the present invention, there is provided an electronic device including a substrate, two ellipse spiral coils, two wires, and a connection portion. The two ellipse spiral coils are provided on the substrate, are spaced from each other in a longitudinal direction thereof, and are electrically connected to each other. The two wires are electrically connected to outermost circumference of the two ellipse spiral coils respectively and extract the two ellipse spiral coils to outside. The connection portion electrically connects each end of innermost circumference of the two ellipse spiral coils. A ratio of inner diameter against outer diameter of the two ellipse spiral coils in a long axis direction and in a short axis direction thereof is respectively 0.5 to 0.8. With the structure, high Q value may be obtained.

According to another aspect of the present invention, there is provided an electronic device including a substrate, two polygonal spiral coils, two wires, and a connection portion. The two polygonal spiral coils are provided on the substrate, are spaced from each other in a longitudinal direction thereof, and are electrically connected to each other. The two wires are electrically connected to outermost circumference of the two polygonal spiral coils respectively and extract the two polygonal spiral coils to outside. The connection portion electrically connects each end of innermost circumference of the two polygonal spiral coils. A ratio of inner diameter against outer diameter of the two polygonal spiral coils in a long axis direction and in a short axis direction of an ellipse circumscribed to the outer circumference and the inner circumference of the two polygonal spiral coils is respectively 0.5 to 0.8. With the structure, high Q value may be obtained.

### BRIEF DESCRIPTION OF THE DRAWINGS

FIG. 1 illustrates a top view of an inductor in accordance with a comparative embodiment;

FIG. 2 illustrates Q values with respect to d/D of the inductor in accordance with the comparative embodiment;

FIG. 3 illustrates a perspective view of an inductor having a number of turns of 8.5 in accordance with a first embodiment;

FIG. 4 illustrates a top view of the inductor having the number of turns of 8.5 in accordance with the first embodiment;

FIG. 5 illustrates a perspective view of an inductor having the number of turns of 4.5 in accordance with the first embodiment;

FIG. 6 illustrates a top view of the inductor having the number of turns of 4.5 in accordance with the first embodiment;

FIG. 7 illustrates Q values with respect to d/D of the inductor in accordance with the first embodiment;

FIG. 8 illustrates Q values with respect to d/D of the inductor in accordance with the first embodiment;

FIG. 9 illustrates Q values with respect to d/D of the inductor in accordance with the first embodiment;

FIG. 10 illustrates Q values with respect to d/D of the inductor in accordance with the first embodiment;

FIG. 11 illustrates Q values with respect to d/D of the inductor in accordance with the first embodiment;

FIG. 12 illustrates Q values with respect to d/D of the inductor in accordance with the first embodiment;

FIG. 13 illustrates a top view of an inductor in accordance with a second embodiment;

FIG. 14 illustrates a top view of the inductor in accordance with the second embodiment;

FIG. 15 illustrates a perspective view of an inductor in accordance with a third embodiment;

FIG. 16 illustrates a top view of the inductor in accordance with the third embodiment;

FIG. 17 illustrates a perspective view of an integrated passive device in accordance with a fourth embodiment; and

FIG. 18 illustrates a top view of the integrated passive device in accordance with the fourth embodiment.

### DESCRIPTION OF THE PREFERRED EMBODIMENTS

In order to facilitate better understanding of the present invention, a description will now be given of related art.

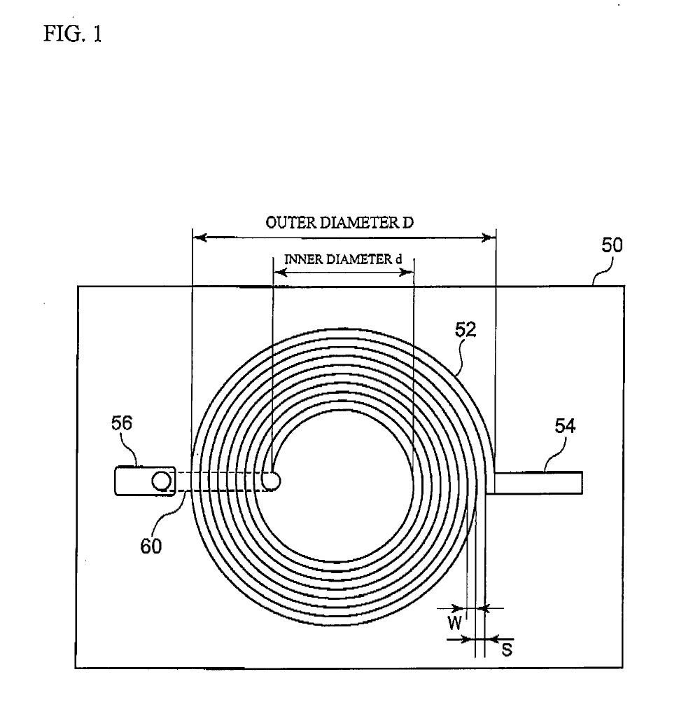

An inductor having a spiral-shaped single layer coil on a substrate was manufactured as a comparative embodiment A relationship between the shape of the coil and Q value was measured. FIG. 1 illustrates a top view of the spiral-shaped coil in accordance with the comparative embodiment. As shown in FIG. 1, there is provided a coil 52 on a substrate 50 made of glass, the coil 52 being made of copper, having thickness of approximately 10 μm and having a spiral shape. An outer end of the coil 52 is connected to outside of the inductor via a wire 54. An inner end of the coil 52 is connected to outside via a wire 56 and a wire 60. The wire 60 is provided above the coil 52 and is spaced from the coil 52 through air. The coil 52 has a circular shape. There is no pattern in the center region of the coil 52. An outer diameter, an inner diameter, a wire width, a wire interval and a number of turns of the coil 52 are referred to as D, d, W, S, and R respectively. The number of turns R of the coil shown in FIG. 1 is 4.5.

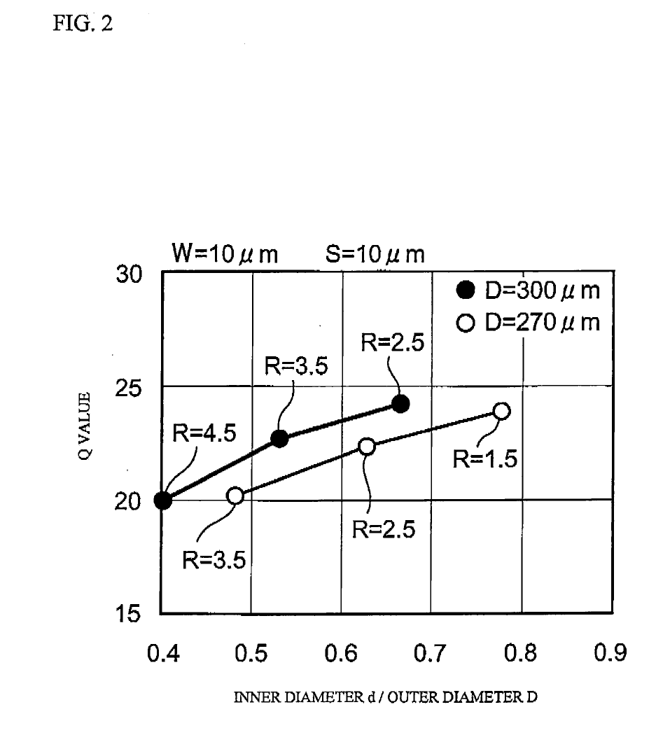

FIG. 2 illustrates a relationship between the Q value measured with respect to the inductor in accordance with the comparative embodiment and d/D that is a ratio of the inner diameter against the outer diameter D. The Q values were measured at a frequency of 1.93 GHz. The coil 52 has the wire width W of 10 μm and the wire interval S of 10 μm. The Q values of the inductor having the outer diameter D of 300 μm and 270 μm are shown as black circle and white circle respectively. The number of turns R is determined within a range of 1.5 to 4.5. As shown in FIG. 2, the d/D is reduced when the number of turns R is enlarged. The Q value is reduced when the d/D is reduced. This is because eddy-current is generated in the wire 60 and the coil 52 and loss is enlarged when the wire 60 shown in FIG. 1 is lengthened. As mentioned above, it is necessary to provide the wire 60 overlapping with the coil 52 for connecting the coil 52 to outside, if the spiral-shaped coil 52 is formed with a single layer wire. The Q value is therefore enlarged when the d/D is enlarged as shown in FIG. 2.

It is, however, confirmed that the Q value indicates maximum with respect to the d/D in an inductor having spiral-shaped coils spaced from each other in a longitudinal direction thereof. A description will be given of embodiments of the present invention.

### First Embodiment

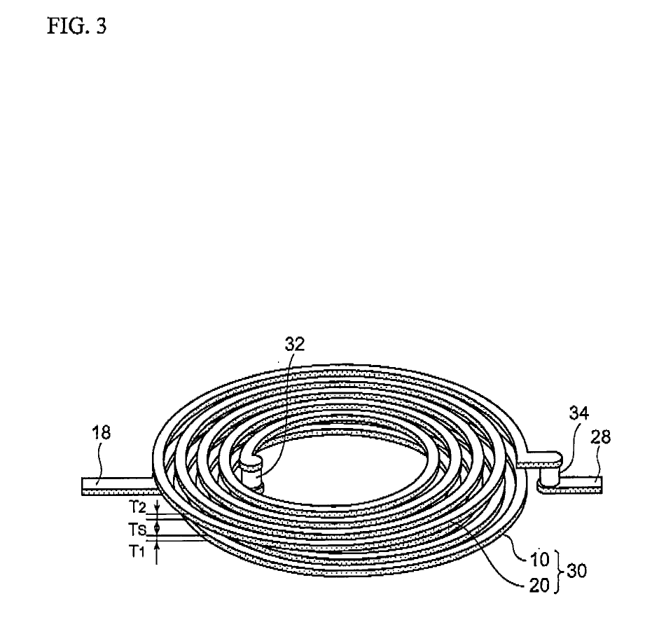

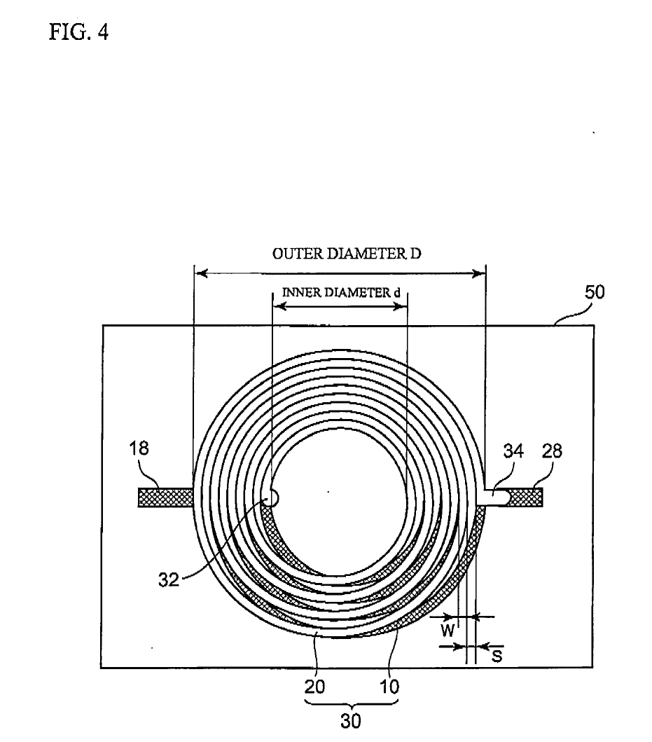

FIG. 3 illustrates a perspective view of an inductor in accordance with a first embodiment of which number of turns R is 8.5 (a number of turns of a second coil and a first coil is 4.5 and 4 respectively). FIG. 4 illustrates a top view of the inductor. As shown in FIG. 3 and FIG. 4, a first coil 10 having a spiral shape is provided on the substrate 50 made of glass, and a second coil 20 having a spiral shape is provided on the first coil 10. The first coil 10 and the second coil 20 are spaced from each other. A space is formed between the first coil 10 and the second coil 20. That is, air is filled between the first coil 10 and the second coil 20. The first coil 10 is almost overlapped with the second coil 20. There are provided wires 18 and 28 that are made of the same metal layer as the first coil 10 and are configured to be connected to outside of an inductor 30. The wire 18 is directly connected to an end of an outermost circumference (that is an outer end) of the first coil 10. A connection portion 34 is provided at an end of an outermost circumference of the second coil 20. The wire 28 is electrically coupled to the second coil 20 via the connection portion 34. A connection portion 32 is provided at an end of innermost circumference (that is an inner end) of the first coil 10 and the second coil 20. The first coil 10 and the second coil 20 are electrically coupled to each other via the connection portion 32. The inductor 30 has the first coil 10 and the second coil 20 that are spaced from each other in a longitudinal direction thereof on the substrate 50, are electrically coupled to each other, and have a circular spiral shape.

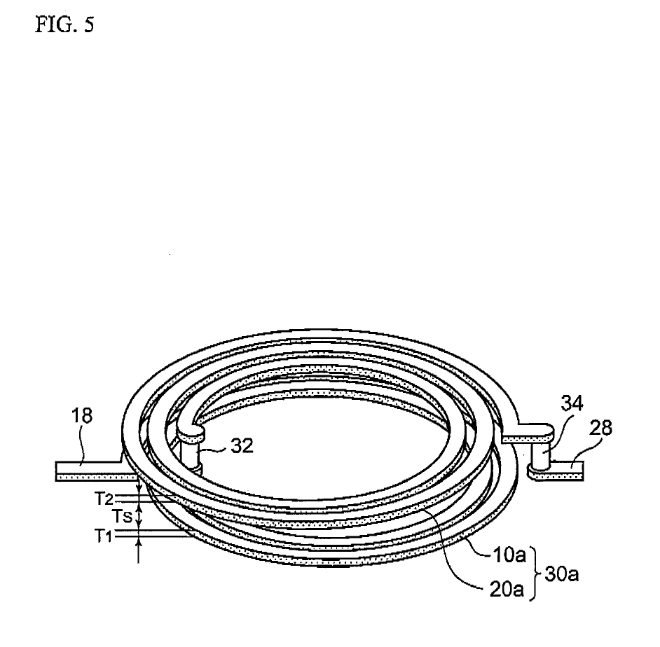

FIG. 5 illustrates a perspective view of an inductor having a number of turns R of 4.5 (a number of turns of the second coil and the first coil is 2.5 and 2 respectively).

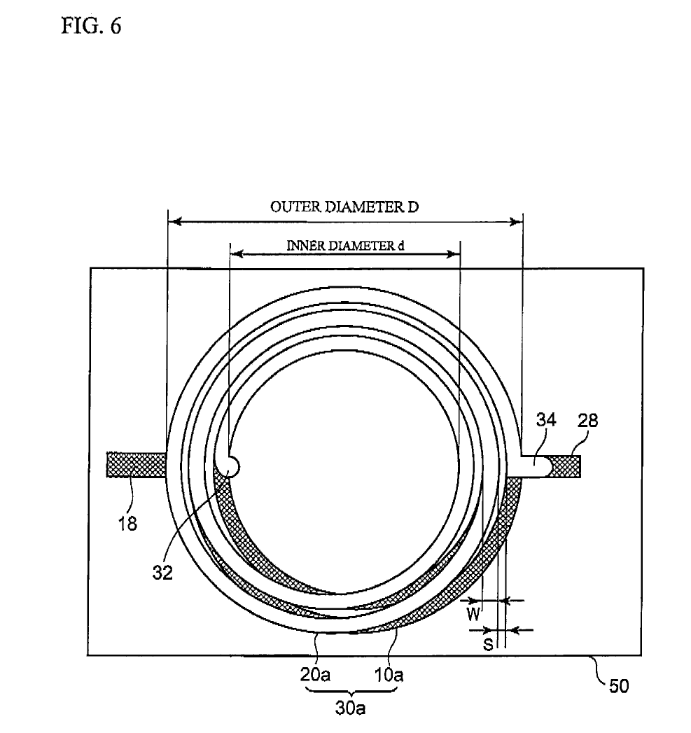

FIG. 6 illustrates a top view of the inductor. The number of turns of a first coil 10a is 2 and the number of turns of a second coil 20a is 2.5, being different from FIG. 3 and FIG. 4. The other structure is the same as that of FIG. 3 and FIG. 4. In the first embodiment, electrical current flows in the same direction in the first coil 10 and the second coil 20. This results in strong inductive connection between the first coil 10 and the second coil 20 and enlargement of inductance.

In FIG. 3 and FIG. 4, the wire 18 to the first coil 10 is connected to the outermost circumference of the first coil 10 so that the wire 18 does not cross with the first coil 10 and the second coil 20, in order to reduce bad effect of the wire 18 to the Q value of the first coil 10 or the second coil 20. The wire 28 is connected to the outermost circumference of the second coil 20 via the connection portion 34. The second coil 20 is arranged overlapping with the first coil 10 as possible in order to strengthen mutual electromagnetic induction between the first coil 10 and the second coil 20. The inner diameter d of the second coil 20 is set to be approximately equal to that of the first coil 10. Similarly, the outer diameter D of the second coil 20 is set to be approximately equal to that of the first coil 10. This results in strengthening of the mutual electromagnetic induction between the first coil 10 and the second coil 20. As an example, the wire width W and the wire interval S of the first coil 10 are the same as those of the second coil 20. And, the number of turns R of the second coil 20 is almost equal to that of the first coil 10. For example, the number of turns of the second coil 20 and the first coil 10 is respectively 4.5, as shown in FIG. 3. It is preferable that differential of the number of turns between the first coil 10 and the second coil 20 is less than 0.5. It is, similarly, preferable that differential of the number of turns between the first coil 10a and the second coil 20a shown in FIG. 5 and FIG. 6 is less than 0.5.

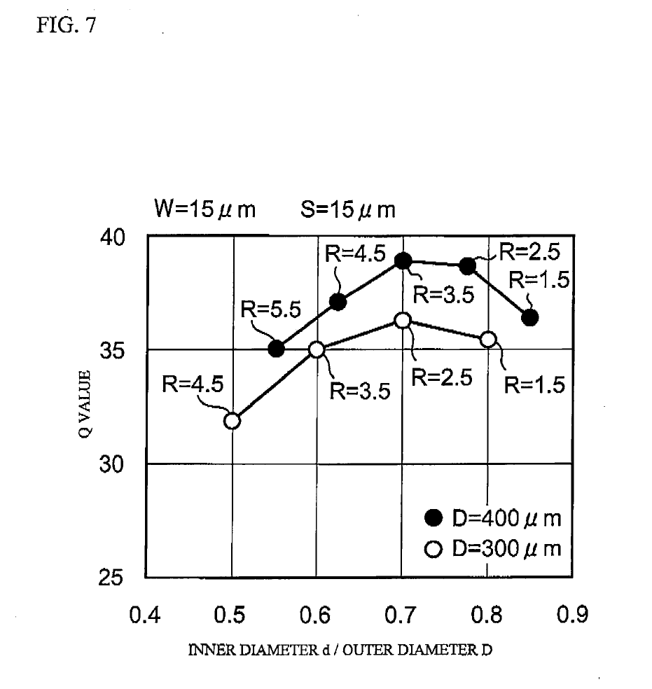

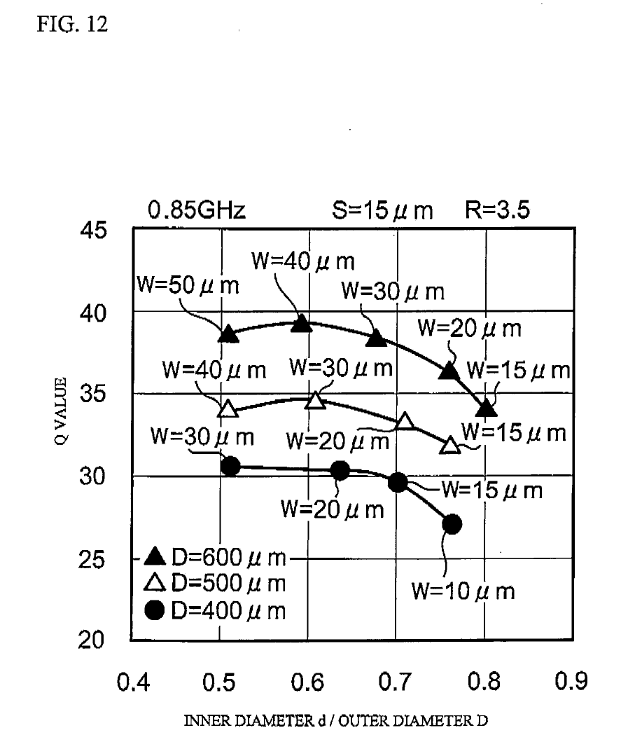

As shown in FIG. 3 through FIG. 6, outer diameter is referred to as D, inner diameter is referred to as d, wire width is referred to as W and wire interval is referred to as S with respect to the first coil 10 and the second coil 20. Thickness of the first coil 10 is referred to as T1. Thickness of the second coil 20 is referred to as T2. An interval between the first coil 10 and the second coil 20 is referred to as TS. The thickness T1 and the thickness T2 are 10 μm and the coil interval TS is 30 μm, in the manufactured inductor. The frequency for measurement of the Q value is 1.93 GHz in FIG. 7 through FIG. 11, and is 0.85 GHz in FIG. 12.

FIG. 7 illustrates the Q value with respect to d/D of an inductor having the wire width W of 15 μm and the wire interval S of 15 μm. The Q values of the inductor having outer diameter D of 400 μm and 300 μm are shown as black circles and white circles respectively. The number of turns R is set to be 1.5 to 5.5. In FIG. 7, the Q value indicates a local maximum when the d/D is approximately 0.7.

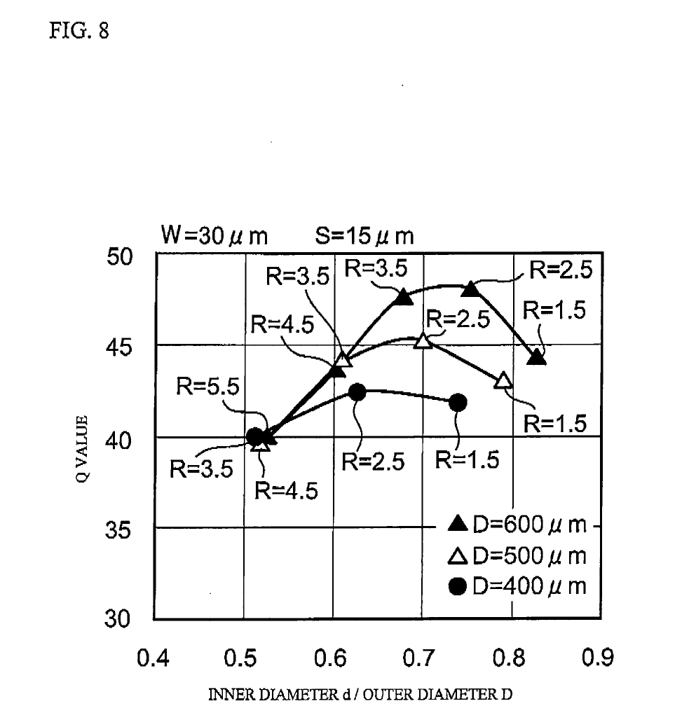

FIG. 8 illustrates the Q values with respect to the d/D of an inductor having the wire width W of 30 μm and the wire interval S of 15 μm. The Q values of the inductor having outer diameter D of 600 μm, 500 μm and 400 μm are shown as black triangles, white triangles and black circles respectively. The number of turns R is set to be 1.5 to 5.5. In FIG. 8, the Q value indicates a local maximum when the d/D is within 0.6 to 0.75.

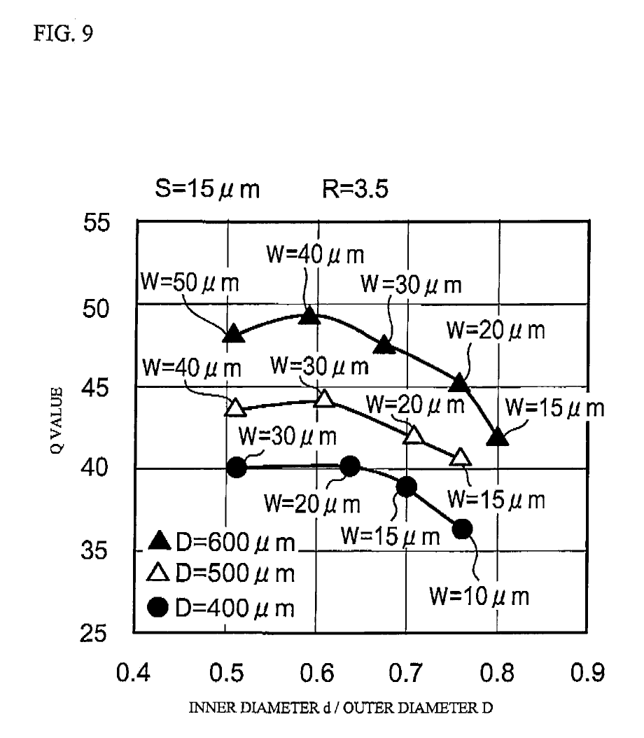

FIG. 9 illustrates the Q value with respect to the d/D of an inductor having the wire interval S of 15 μm and the number of turns R of 3.5. The Q values of the inductor having outer diameter D of 600 μm, 500 μm and 400 μm are shown as black triangles, white triangles and black circles respectively. The wire width W is set to be 10 μm to 50 μm. In FIG. 9, the Q value indicates a local maximum when the d/D is approximately 0.7.

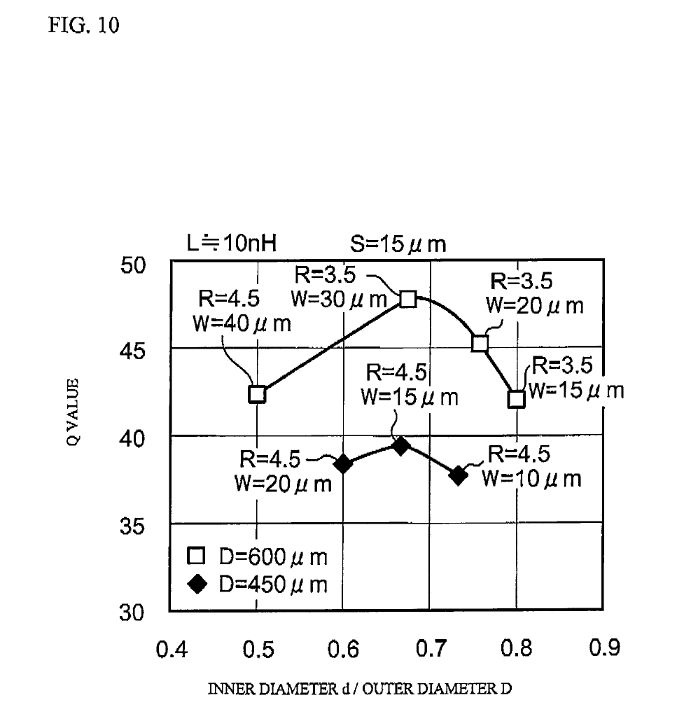

FIG. 10 illustrates the Q value with respect to the d/D of an inductor having the wire interval S of 15 μm obtaining the inductance of approximately 10 nH. The Q values of the inductor having outer diameter D of 600 μm and 450 μm are shown as white square and black rhombic respectively. The number of turns R is set to be 3.5 or 4.5. The wire width W is set to be 10 μm to 40 μm. In FIG. 10, the Q value indicates a local maximum when the d/D is approximately 0.7.

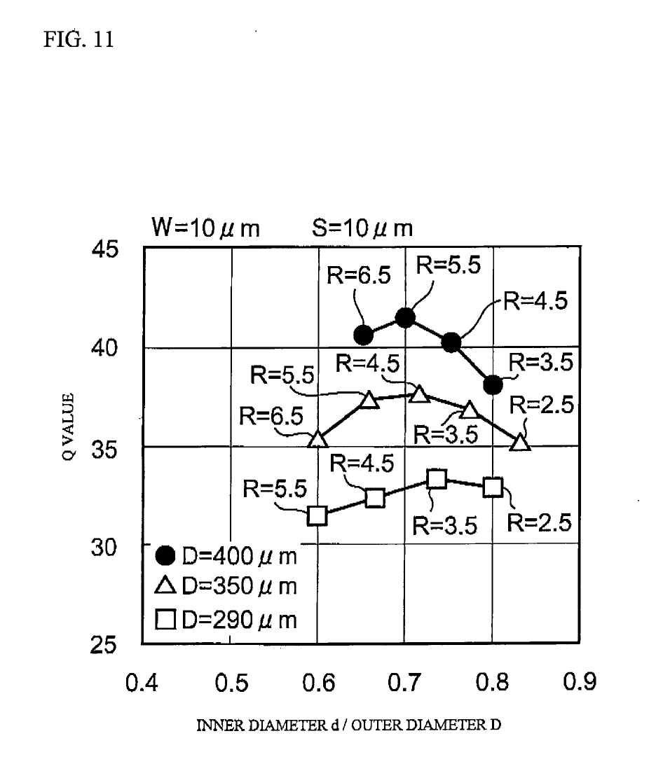

FIG. 11 illustrates the Q value with respect to the d/D of an inductor having the wire width W of 10 μm and the wire interval S of 10 μm. The Q values of the inductor having outer diameter D of 400 μm, 350 μm and 290 μm are shown as black circles, white triangles and white squares respectively. The number of turns R is set to be 2.5 to 6.5. The number of turns R is set to be 2.5 to 6.5. In FIG. 11, the Q value indicates a local maximum when the d/D is within 0.7 to 0.75.

FIG. 12 illustrates a measured result of the Q value of the inductor shown in FIG. 9 at a frequency of 0.85 GHz. Each setting value except for the frequency is the same as that of FIG. 9. It is confirmed that the Q value with respect to the d/D hardly changes even if the frequency changes according to the comparison between FIG. 9 and FIG. 12. It is thought that the Q value with respect to the d/D hardly changes within a frequency range of 0.70 GHz to 6 GHz that is used for a mobile phone. The Q value with respect to the d/D does not change in a frequency range of 0.85 GHz to 1.93 GHz.

As mentioned above, it is confirmed that the Q value indicates the maximum with respect to the d/D in the inductor in which the first coil 10 and the second coil 20 are spaced from each other in a longitudinal direction thereof. The tendency that the d/D indicates local maximum with respect to the Q value is independent of the wire width W, the wire interval S, the outer diameter D, the number of turns R and the measuring frequency, as shown in FIG. 7 through FIG. 12. As shown in FIG. 7 through FIG. 12, the Q value is enlarged when the d/D is within a range of 0.5 to 0.8. The range of the d/D is preferably 0.6 to 0.8 and is more preferably 0.65 to 0.75.

In the comparative embodiment, the Q value is reduced when the d/D is reduced, because of the wire 60 for connecting the coil 52 to outside. On the other hand, there are formed the wires 18 and 28 electrically connected to the first coil 10 and the second coil 20 respectively at the outermost circumference of the first coil 10 and the second coil 20 in the first embodiment, as shown in FIG. 3 and FIG. 4. There is formed the connection portion 32 electrically connecting the first coil 10 and the second coil 20 at each innermost circumference of the first coil 10 and the second coil 20. This results in no overlapping of the wires 18, 28 for connecting the first coil 10 and the second coil 20 to outside with the first coil 10 and the second coil 20. There is little degradation of the Q value caused by an eddy current loss generated by an overlapping between the wire for connecting the coil to outside and the coil. It is therefore thought that the Q value indicates local maximum with respect to the d/D.

The Q value is reduced when the outer diameter D is reduced. The chip size is enlarged when the outer diameter D is enlarged. The outer diameter D is determined in view of these matters. The outer diameter D is preferably within a range of 100 μm to 1 mm, and is more preferably within a range of 290 μm to 600 μm used in the experiment shown in FIG. 7 through FIG. 12.

The wire width W may be determined within a range that the resistance is not enlarged and the d/D is not reduced. The wire width W is preferably 3 μm to 100 μm, and is more preferably 10 μm to 50 μm used in the experiment shown in FIG. 7 to FIG. 12. An optimal value of the number of turns R is determined according to a given inductance, the d/D, the wire width W and the wire interval S. The number of turns R is preferably 0.5 to 30, and is more preferably 1.5 to 6.5 used in the experiment shown in FIG. 7 to FIG. 12.

The thickness T1 of the first coil 10 and the thickness T2 of the second coil 20 are determined within a range that the resistance is not enlarged and the coils are easily manufactured. The thickness T1 and the thickness T2 are preferably 3 μm to 30 μm. The interval TS between the first coil 10 and the second coil 20 is determined within a range that the parasitic capacitance is small and the inductive connection is strengthened. The interval TS is preferably 3 μm to 40 μm.

It is preferable that the substrate 50 is made of highly insulating material. The substrate 50 may be made of an insulating substrate such as quartz (including synthetic quartz), glass (pyrex (registered trademark), tempax, alumino silicate, borosilicate glass) or ceramics. The substrate 50 may be made of a high-resistance Si substrate, a LiNbO₃ substrate, or a LiTaO₃ substrate. It is preferable that the first coil 10 and the second coil 20 are made of low-resistance metal. The first coil 10 and the second coil 20 may be made of gold, aluminum, silver in addition to copper. It is preferable that the layer of the first coil 10 in touch with the substrate 50 is made of high-melting point metal having high adhesiveness to the substrate, for example metal such as Ti, Cr, Ni, Mo, Ta, W. It is preferable that there is air between the first coil 10 and the second coil 20 in order to restrain the parasitic capacitance. There may be formed a dielectric layer between the first coil 10 and the second coil 20. It is preferable that the dielectric layer is low-permittivity dielectric layer having lower permittivity than silicon oxide, in a case where the dielectric layer is provided between the first coil 10 and the second coil 20. The manufacturing method of the inductor in accordance with the first embodiment may be that of Japanese Patent Application Publication No. 2007-67236.

### Second Embodiment

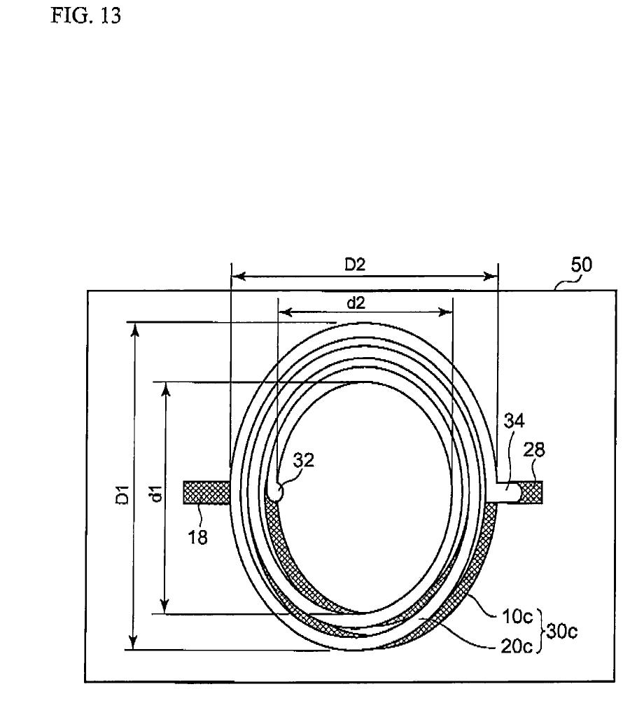

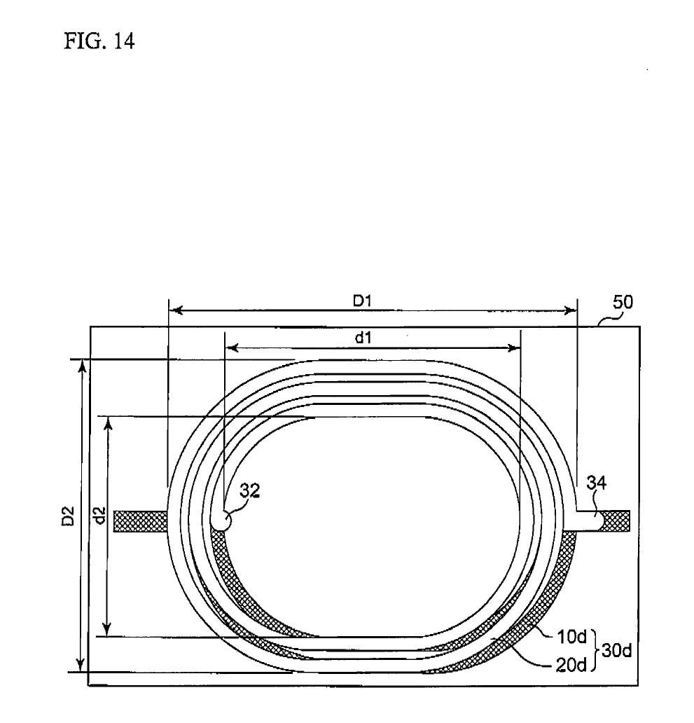

A second embodiment is an example of an ellipse-shaped coil. As shown in FIG. 13, a first coil 10c and a second coil 20c of an inductor 30c have an ellipse shape. A direction from the wire 18 to the wire 28 is a short axis direction. A direction vertical to the short axis is a long axis direction. As shown in FIG. 14, a first coil 10d and a second coil 20d of an inductor 30d have an ellipse shape. In FIG. 13 and FIG. 14, an outer diameter and an inner diameter are referred to as D1 and d1 respectively, and an outer diameter and an inner diameter are referred to as D2 and d2.

The first coil 10 and the second coil 20 may have the ellipse spiral shape, similarly to the second embodiment. The direction of the wires 18 and 28 may be the short axis as shown in FIG. 13. The direction of the wires 18 and 28 may be the long axis as shown in FIG. 14. The long axis and the short axis may be oblique with respect to the wires 18 and 28. The ellipse shape may be geometric ellipse shape as shown in FIG. 13 and may be broad ellipse shape as shown in FIG. 14. The ellipse shape may include the circular shape shown in FIG. 3 through FIG. 6. High Q value may be obtained when a ratio of the inner diameter against the outer diameter on the long direction and the short direction is 0.5 to 0.8, in a case where the first coil 10 and the second coil 20 have the ellipse shape.

### Third Embodiment

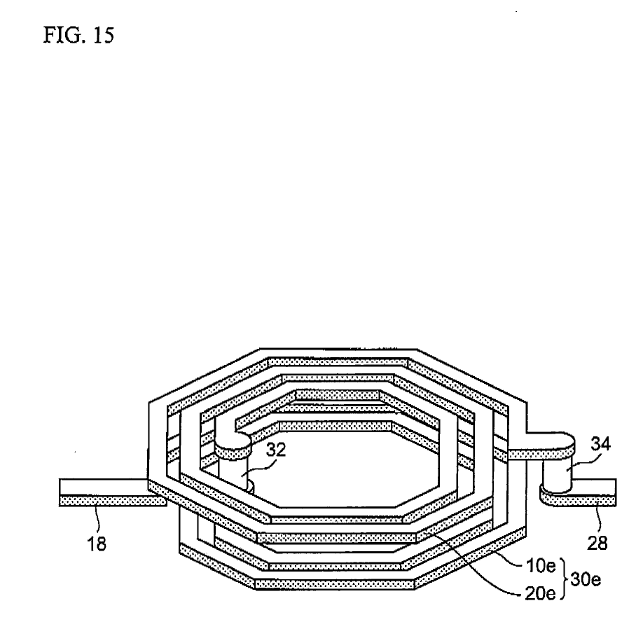

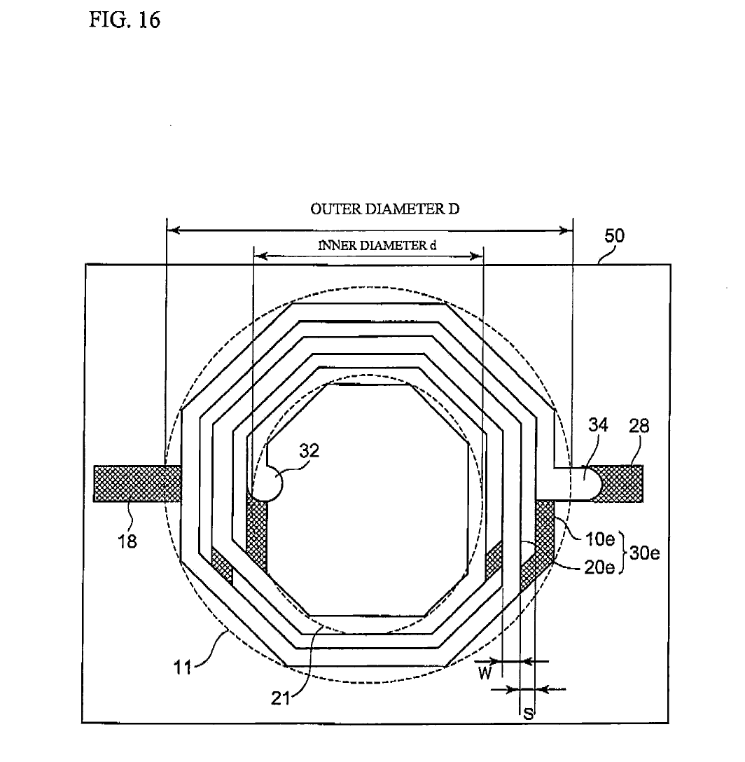

A third embodiment is an example where the coil has polygonal shape. FIG. 15 illustrates a perspective view of an inductor 30e in accordance with the third embodiment. FIG. 16 illustrates a top view of the inductor 30e. As shown in FIG. 15 and FIG. 16, a first coil 10e and a second coil 20e of the inductor 30e have octagonal shape. The first coil 10 and the second coil 20 may have polygonal spiral shape, similarly to the third embodiment. The outer diameter D of the first coil 10 and the second coil 20 may be defined with a circle 11 circumscribed to the outermost circumference thereof. The inner diameter d of the first coil 10 and the second coil 20 may be defined with a circle 21 circumscribed to the innermost circumference thereof. The circle 11 and the circle 21 may have an ellipse shape. In this case, high Q value may be obtained when a ratio of the inner diameter against the outer diameter on the long axis and the short axis of the ellipse circles circumscribed to the outermost circumference and inscribed to the innermost circumference of the first coil 10 and the second coil 20 is 0.5 to 0.8.

In the first through third embodiments, the two coils are spaced from each other in the longitudinal direction thereof. However, more than two coils are spaced from each other in the longitudinal direction thereof.

### Fourth Embodiment

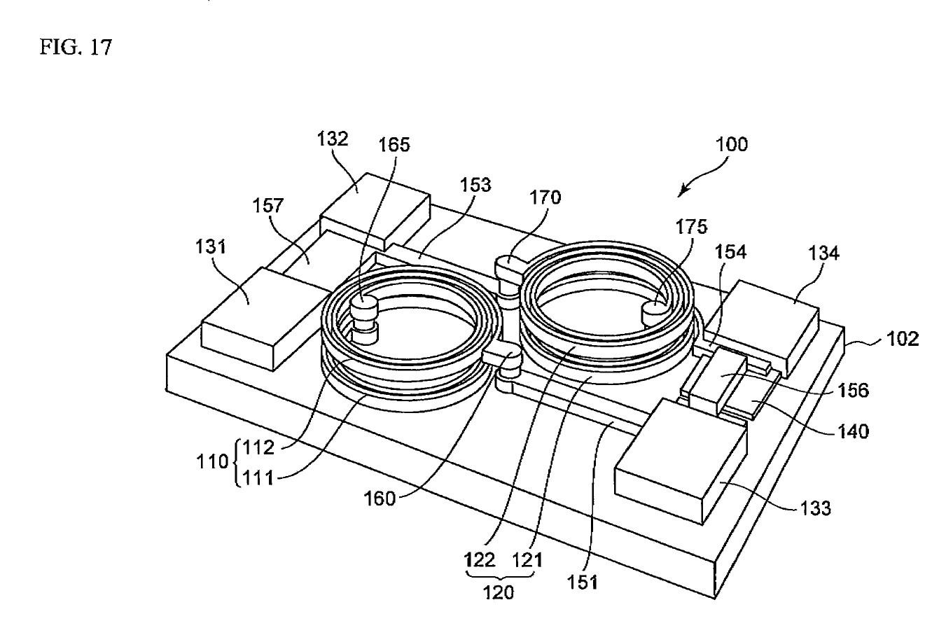

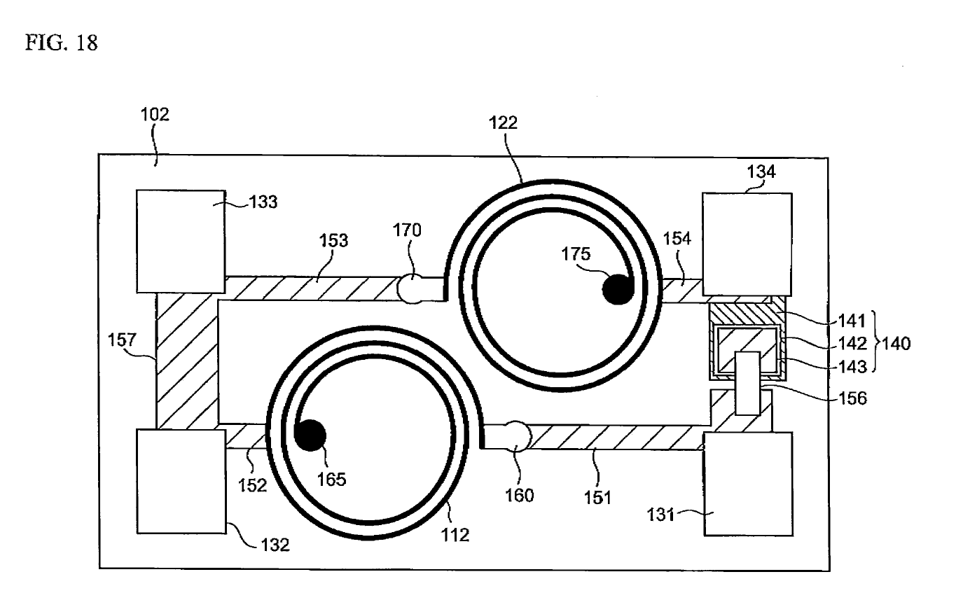

A fourth embodiment is an example of an integrated passive device having the inductor in accordance with the first embodiment. FIG. 17 illustrates a perspective view of an integrated passive device 100 in accordance with the fourth embodiment. FIG. 18 illustrates a top view of the integrated passive device 100. First coils 111 and 121 are not shown in FIG. 18. As shown in FIG. 17 and FIG. 18, there are provided an inductor 110 having the first coil 111 and a second coil 112 and an inductor 120 having the first coil 121 and a second coil 122. The inductors 110 and 120 are the inductors in accordance with the first embodiment. The inner end of the first coil 111 and the second coil 112 in the inductor 110 is electrically connected to each other through a connection portion 165. The outer end of the first coil 111 is connected to a wire 152. The outer end of the second coil 112 is electrically connected to a wire 151 through a Connection portion 160. The inner end of the first coil 121 and the second coil 122 in the inductor 120 are connected to each other with a connection portion 175. The outer end of the first coil 121 is connected to a wire 154. The outer end of the second coil 122 is connected to a wire 153 through a connection portion 170. The wires 151 through 154 are formed on a substrate 102 and connected to pads 131 through 134 respectively. The pad 132 is connected to the pad 133 with a wire 157. A capacitor 140 having a lower electrode 141, a dielectric layer 142 and an upper electrode 143 is connected between the pad 131 and the pad 134. The upper electrode 143 is connected to the wire 151 with an upper wire 156.

The integrated passive device 100 forms a π type L-C-L circuit, if the pad 131 acts as an input, the pad 134 acts as an output, and the pad 132 and the pad 133 are grounded. In accordance with the fourth embodiment, high-performance integrated passive device may be provided when the inductors 110 and 120 have the d/D of 0.5 to 0.8.

The present invention is not limited to the specifically disclosed embodiments, but variations and modifications may be made without departing from the scope of the present invention.

The present invention is based on Japanese Patent Application No. 2007-254660 filed on Sep. 28, 2007, the entire disclosure of which is hereby incorporated by reference.

What is claimed is:

1. An electronic device comprising:
a substrate;
two ellipse spiral coils that are provided on the substrate, are spaced from each other in a longitudinal direction thereof, and are electrically connected to each other;
two wires that are electrically connected to outermost circumference of the two ellipse spiral coils respectively and extract the two ellipse spiral coils to outside; and
a connection portion that electrically connects each end of innermost circumference of the two ellipse spiral coils,
wherein a ratio of inner diameter against outer diameter of the two ellipse spiral coils in a long axis direction and in a short axis direction thereof is respectively 0.5 to 0.8.

2. The electronic device as claimed in claim 1, wherein there is air between the two ellipse spiral coils.

3. The electronic device as claimed in claim 1, wherein electrical current flows in the same direction in the two ellipse spiral coils.

4. The electronic device as claimed in claim 1, wherein the two ellipse spiral coils have circular spiral shape.

5. The electronic device as claimed in claim 1, wherein the two ellipse spiral coils have thickness of 3 μm to 30 μm.

6. The electronic device as claimed in claim 1, wherein an interval between the two ellipse spiral coils is 3 μm to 40 μm.

7. An electronic device comprising:
a substrate;
two polygonal spiral coils that are provided on the substrate, are spaced from each other in a longitudinal direction thereof, and are electrically connected to each other;
two wires that are electrically connected to outermost circumference of the two polygonal spiral coils respectively and extract the two polygonal spiral coils to outside; and
a connection portion that electrically connects each end of innermost circumference of the two polygonal spiral coils,
wherein a ratio of inner diameter against outer diameter of the two polygonal spiral coils in a long axis direction and in a short axis direction of an ellipse circumscribed to the outer circumference and the inner circumference of the two polygonal spiral coils is respectively 0.5 to 0.8.

8. The electronic device as claimed in claim 7, wherein there is a space between the two polygonal spiral coils.

9. The electronic device as claimed in claim 7, wherein electrical current flows in the same direction in the two polygonal spiral coils.

10. The electronic device as claimed in claim 7, wherein the two polygonal spiral coils have circular spiral shape.

11. The electronic device as claimed in claim 7, wherein the two polygonal spiral coils have thickness of 3 μm to 30 μm.

12. The electronic device as claimed in claim 7, wherein an interval between the two polygonal spiral coils is 3 μm to 40 μm.
